(19) United States
(12) Patent Application Publication
(10) Pub. No.: US 2015/0068047 A1
(43) Pub. Date: Mar. 12, 2015

(54) SPOON FOR ADMINISTERING A MEDICATION

(71) Applicants: Adam Leffler, Salt Lake City, UT (US); Zack Bybee, Draper, UT (US); Melinda Fox, Draper, UT (US)

(72) Inventors: Adam Leffler, Salt Lake City, UT (US); Zack Bybee, Draper, UT (US); Melinda Fox, Draper, UT (US)

(21) Appl. No.: 14/543,647

(22) Filed: Nov. 17, 2014

Related U.S. Application Data
(63) Continuation-in-part of application No. 13/220,414, filed on Aug. 29, 2011, now Pat. No. 8,898,912.
(60) Provisional application No. 61/993,859, filed on May 15, 2014.

(51) Int. Cl. A61J 7/00

(52) U.S. Cl. CPC A61J 7/0023
USPC 30/324

(57) ABSTRACT

A spoon for administering a carrier medium includes a bowl and a handle. Various configurations of the bowl or handle can allow a carrier medium or medication to be more easily dispensed.

### CROSS-REFERENCE TO RELATED APPLICATIONS

This application is a continuation-in-part of U.S. patent application Ser. No. 13/220,414 which was filed on Aug. 29, 2011. This application also claims the benefit of U.S. Provisional Patent Application No. 61/993,859 which was filed on May 15, 2014.

### BACKGROUND

In nursing homes, schools, prisons, hospitals, hospices and other skilled nursing facilities is often required to administer medicine to a patient who is either not able to self-administer or where it would be more beneficial to assure that the medicine be administered by a caregiver. In a typical environment the caregiver verifies the temperature of the medium such as applesauce; a spoon is dipped into the applesauce and a medicine is crushed into the applesauce and then administered to the patient. Problems with this technique are that the medium such as applesauce may become adulterated or cross contaminated as several spoons are dipped into the medium. The temperature can rise over time making the medium less desirable or dangerous if left in a warm environment for too long of a period. In addition, because the medication is ground and added to the carrier, if not all of the carrier medium is consumed, than a less than medically effective amount of medicine could be administered.

### BRIEF SUMMARY

In some embodiments, the invention comprises a handle and a bowl which are designed to easily fit into the human mouth. Within the bowl is a medium such as a gel, a gelatin, a pudding, or natural foods such as applesauce. In some embodiments a medically effective amount of medicine has been premixed into the carrier medium before sealing the carrier medium in the bowl of the spoon. A protective seal than covers the top of the bowl and the entire device is pasteurized so that the device can then be packed in a sterile container and will remain sterile until administration. The spoon is constructed of food grade plastic to survive the pasteurization/sterilization process without any detrimental effects. In some embodiments, the handle is shaped with a groove so that a finger may be slid into the groove and under a portion of the film seal to assist in removal of the film seal from the top of the bowl. The top of the bowl of the spoon is designed to have smooth edges that will not damage the human mouth. The spoon can be constructed using a mold press. Once the spoons are molded from food grade plastic they are sanitized, filled with carrier medium and sealed. The entire filled and sealed spoon is then pasteurized and sterilized. They are then immediately packaged into a sanitarily lined container which is then sealed. In use, a caregiver grasps the spoon by the end of the handle and uses a second hand to slide a thumb or finger along a groove molded into the handle to assist in pulling the seal lip back away from the bowl of the spoon. Using the hand that has been holding the handle, the person can then either introduce an effective amount of medicine into the bowl or locate medicine within the handle of the device and place that into the bowl with the carrier and mix it therewith. Some embodiments have a detachable mixing extension which can be removed from the end of the spoon to mix the medicine with the carrier medium found in the bowl or the spoon. The bowl is shaped so that the final portion of the bowl which would enter a patient's mouth are shallower and tapered to fit more easily and comfortably into the human mouth.

In other embodiments, a spoon for administering a carrier medium can comprise a bowl and a handle attached to the bowl. The handle can have a hollow interior and include a hole forming an opening from the hollow interior to the bowl thereby allowing a carrier medium contained within the hollow interior to be expelled from the hollow interior into the bowl. In some embodiments, the spoon may include a cover that opens to provide access to the hollow interior. The cover may include a slot within which a sliding member slides. The sliding member can include a blade that extends into the hollow interior. The blade can be configured to provide a force against a package of carrier medium contained within the hollow interior to cause the carrier medium to be expelled into the bowl. In other embodiments, the spoon may include a plunger that inserts into the handle to force the carrier medium through the hole and into the bowl.

In other embodiments, a spoon for administering a carrier medium can include a bowl and a handle that extends proximally from the bowl. The handle can include a first folding region, a second folding region proximal to the first folding region, a receptacle area between the first and second folding regions, and a crushing area positioned proximal to the second folding region. When the handle is folded along the second folding region, the crushing area can insert into the receptacle area.

In other embodiments, a spoon for administering a carrier medium can include a bowl and a handle. In some embodiments, the bowl can include an opening into which a cup containing a carrier medium or medication can be placed. In some embodiments, the handle can be arched and the spoon can include a flat region positioned between the bowl and the handle. The flat region can be planar with a top surface of the bowl. In some embodiments, the bowl can be a primary bowl and the spoon can include a secondary bowl adjacent the primary bowl. In some embodiments, the bowl can be retractable from the handle. In some embodiments, the handle can include a channel within which a strip slides. The strip can include a number of compartments for storing medication.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a spoon delivery device having an indentation in the handle, a carrier medium and a seal;

FIG. 2 shows an embodiment having a bowl in a sealed condition;

FIG. 3 is a cross sectional cut away view of the embodiment shown in FIG. 2 illustrating the seal on the bowl of the spoon with the carrier and medicine contained therein;

FIG. 4 is a perspective cut away view of an embodiment which contains a medication shown in a solid form which could also be a gel or a liquid stored within the handle. A medicine container in the handle of the spoon can be used so that the medicine can be kept in the handle of the spoon in cases where mixing the medicine with the carrier would shorten the shelf life or be undesirable for other reasons;

FIG. 5 shows the embodiment of FIG. 4 in a sealed condition;

FIG. 6 shows a cross-section of the embodiment of FIG. 5 with a medicine stored both in the handle and in the bowl;

FIG. 7-12 show various embodiments of the spoon from different viewpoints;

FIG. 13 shows an embodiment having an oral channel;

FIG. 14 shows an embodiment of the spoon having a breakaway stirring device located in the handle of the spoon;

FIG. 15 shows the stirring device broken away from the handle of the spoon;

FIG. 16 shows an embodiment with a hinged handle;

FIG. 17 depicts an embodiment wherein a squeeze tube is detachably joined to the handle;

FIGS. 18A-18D illustrate a spoon having a hollow handle in which a packaged carrier medium can be placed;

FIGS. 19A and 19B illustrate a spoon having a hollow handle with a plunger;

FIG. 20 illustrates a spoon having a removable bowl;

FIGS. 21A-21D illustrate a spoon having a foldable handle;

FIGS. 22A-22D illustrate a spoon having a bowl within which an opening is formed for holding a cup;

FIGS. 23A and 23B illustrate spoons having arched handles and a flat region to which a seal can be adhered;

FIGS. 24A and 24B illustrate a spoon having multiple bowls;

FIGS. 25A and 25B illustrate a spoon having a sliding bowl; and

FIGS. 26A and 26B illustrate a spoon that includes a number of compartments for storing medication.

### DETAILED DESCRIPTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

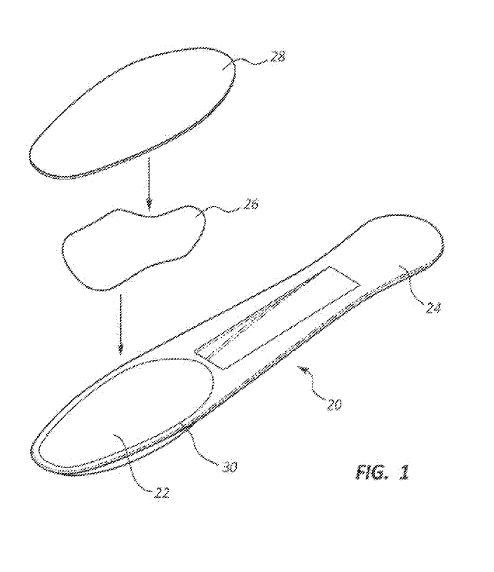

Turning now to FIG. 1, a spoon-shaped medication delivery device or spoon 20 is shown having a bowl 22 and a handle 24. A carrier medium 26 can be a natural food such as applesauce or pudding or a gel or gelatin formulation. It may be desirable to create a carrier medium that is cohesive so it comes off the spoon in one piece to assure that all of the medication is consumed. Gel or gelatins may be required to avoid interaction of a natural food with the medication if stored for a long period of time. A seal 28 covers carrier medium 26 when placed into the bowl 22 and seals across a top or lip 30 of bowl 22.

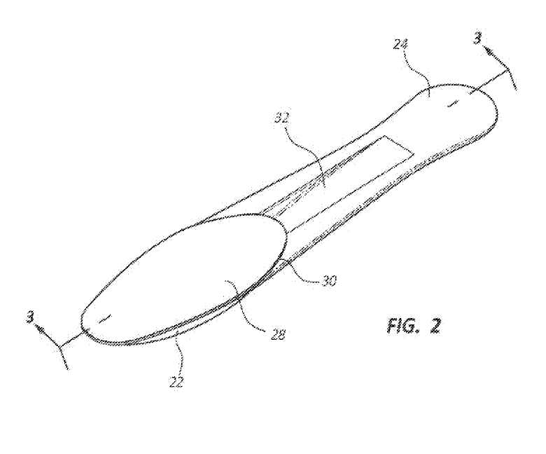

Turning now to FIG. 2, the device described in FIG. 1 is shown in its assembled condition. Seal 28 is now adhered to the top 30 of bowl 22 and covers a portion of a groove or indentation 32 formed in handle 24. Groove 32 allows a thumb or finger of a caregiver or user to be slid into the groove and under seal 28 to easily allow seal 28 to be peeled away from top 30 of bowl 22.

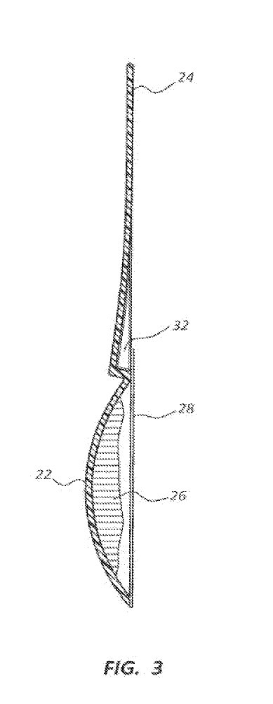

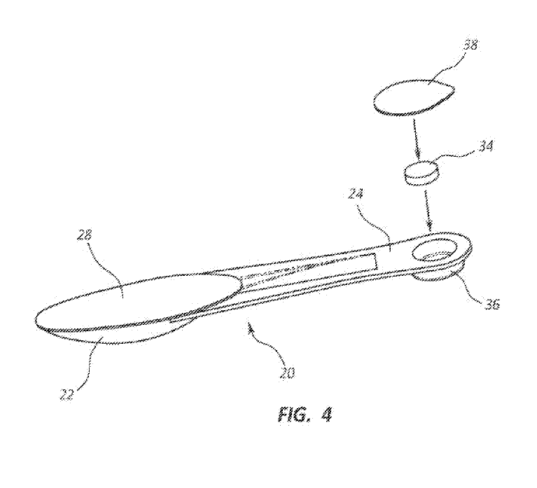

FIG. 3 is a cross-sectional view of the embodiment shown in FIG. 2 showing the carrier medium 26 sealed within bowl 22 by seal 28. FIG. 4 shows an embodiment of the spoon or medicine delivery device showing a sealed bowl having only carrier medium 22. In this embodiment medicine or a medication 34 is shown stored in a well 36 formed in the handle 24. In this embodiment a well seal 38 seals medication 34 within well 36 so that the medication remains in a sterile condition. Just prior to use, in this embodiment seal 38 would be removed and medication 34 would be taken out of the handle 24 and broken or ground. Seal 28 would be removed from the bowl 22 and the ground medication would be mixed with the carrier medium 26 held in the bowl 22 and then would be administered to the patient. FIG. 5 shows the embodiment shown in FIG. 4 in its assembled form having both well seal 38 and the seal over the bowl 28 affixed to the spoon 20. A tab 40 can be seen extending beyond well 36 so that the user may grasp well seal 38 and easily remove the seal when access to medication 34 is required.

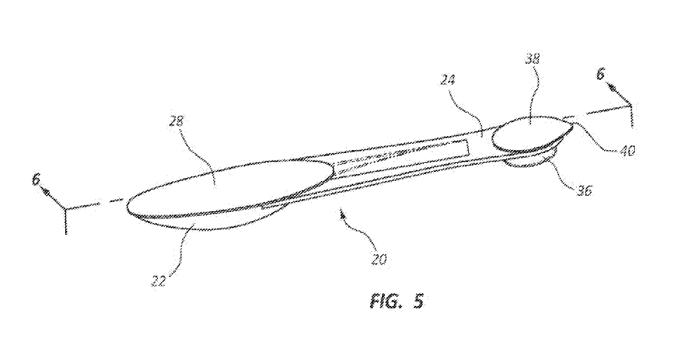

FIG. 6 is a cross-sectional view of an embodiment that has a well 36 located in handle 24 and a well seal 38 within which a medication may be stored. This embodiment also has within the carrier medium 26 a separate medication which can be easily stored without degradation with the carrier medium 26. In this embodiment, two medications can be administered at the same time even though those two medications may not store well when combined. By storing one medication in well 36 and the second medication premixed with the carrier medium 26 a variety of medications can be administered at the same time which might not be able to be stored in the same location.

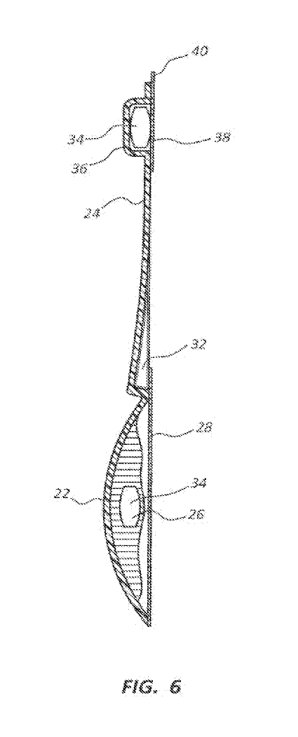

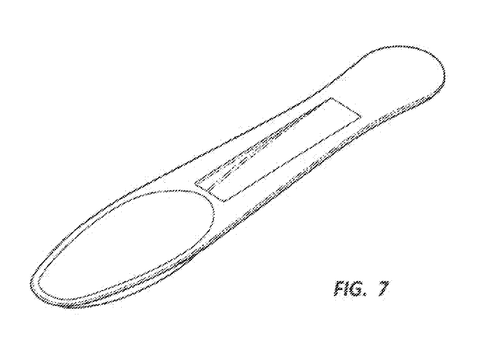

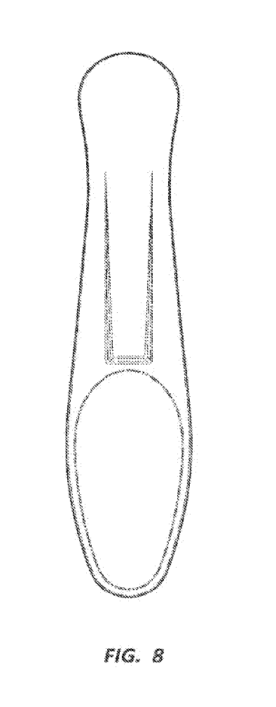

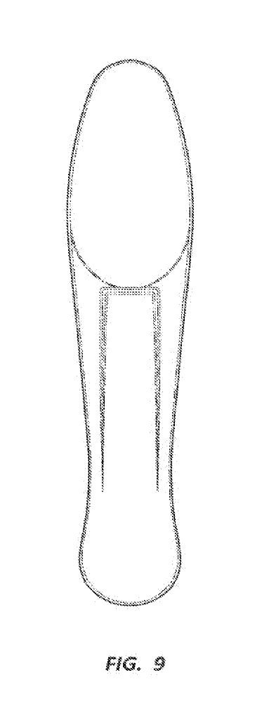

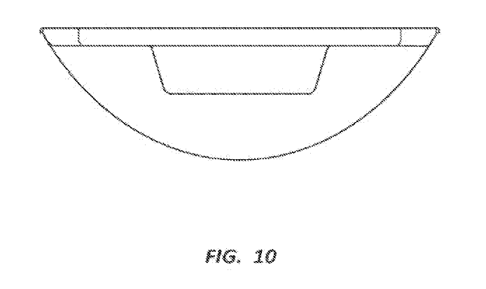

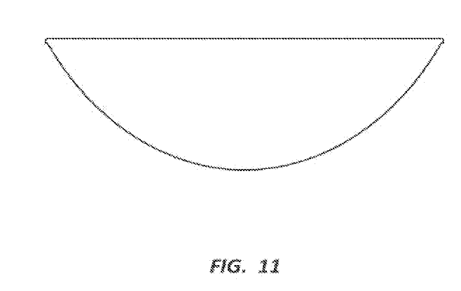

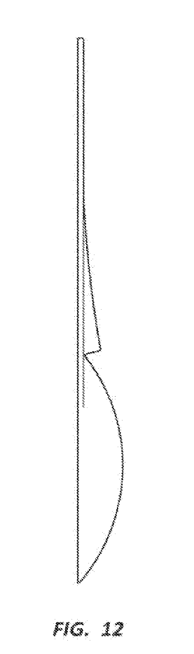

FIGS. 7 through 12 show an embodiment of the present invention from several viewpoints

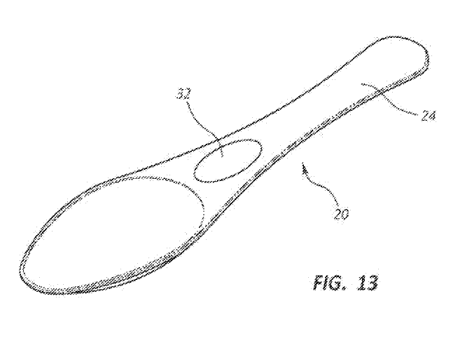

FIG. 13 shows an embodiment of the invention having a groove 32 which has a generally oval shape which may be preferable in some environments for production storage or for allowing easy release of seal 28.

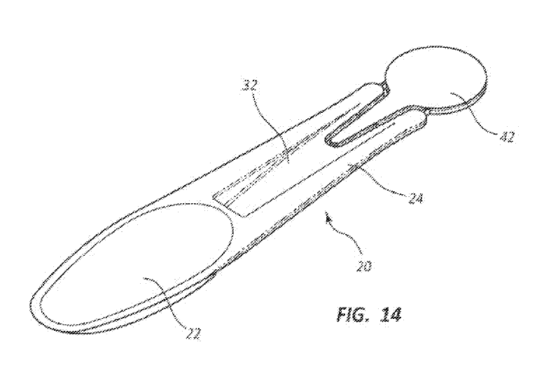

FIG. 14 shows an embodiment having a bowl 22 and handle 24 with groove 32 but in this embodiment a mixing device 42 is attached to spoon 20.

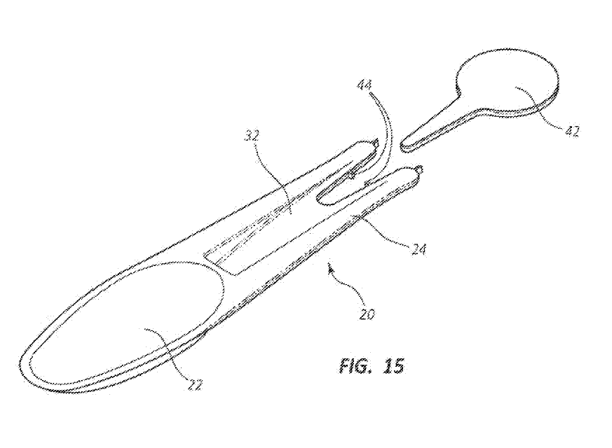

FIG. 15 shows mixing device 42 having been broken away from handle 24 where it was attached by attachment points 44. Mixing device 42 is used to combine medication with the carrier medium 26 in bowl 22 prior to administration to a patient.

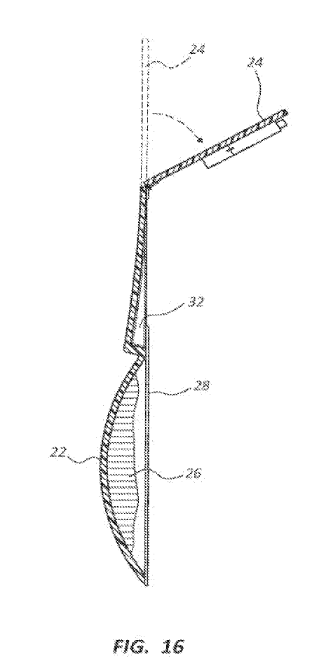

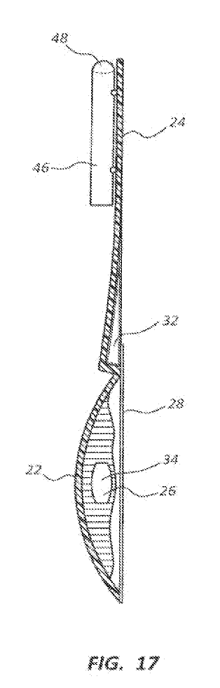

FIG. 16 illustrates an embodiment that has a folding handle 24. FIG. 17 illustrates an embodiment that has a tube 46 formed as part of handle 24 and a cap 48 which is capable can be removed to allow access to the contents of tube 46. Tube 46 may either be detachable so that the contents of the tube can be added to the carrier medium 26 in bowl 22 and then stirred and administered, or in some embodiments with the folding handle 24, tube 46 is oriented so that its contents can be squirted directly into bowl 22 when in the folded position.

It will be appreciated by those skilled in the art that carrier medium 26 can be comprised of many different ingredients including traditional applesauce or other food items which can be sealed in bowl 22. However, carrier medium 26 can also be created of artificial ingredients forming a gel that provides for a long shelf life and may be sufficiently flavored so that the taste of some medications can be masked. Bowl 22, because of its more shallow shape, allows insertion of the spoon into the mouth of patients who cannot fully open their mouth. The tapered shape of the bowl allows for insertion of the spoon between the lips and parts the lips of a patient. Additionally, handle 24 is designed with a wide surface for a firm grip by caregivers as well as for allowing for groove 32 to form a channel in the handle guiding a user's thumb for easy removal of seal 28. In some embodiments, the carrier medium 26 has a slurry-like consistency and is preloaded with medication in those instances that will not deleteriously affect the shelf life. In most embodiments, the slurry has no lactose or glucose, and instead natural sweeteners such as stevia are used. In some of these formulas rice milk is used. Since the glue holding the seal 28 to the bowl 22 may also undergo pasteurization, food grade plastics and adhesives can be used so that when the entire sealed spoon undergoes a 200 degree hot bath and then is quickly cooled, the entire device will be sterile and is carefully handled so that it is not contaminated as it is being packed into sterile packaging. The medically effective spoon may then be removed and administered to a patient without concern for contamination. By sterilizing each spoon and administering it to one patient, the chance of cross contamination is eliminated. In some embodiments, no pasteurization is required.

A benefit of having a single serving spoon is that all of the contents are consumed by the patient and therefore all of the medication therein will be consumed. Many carrier mediums 26 because of their gel-like consistency slide out of bowl 22 in one piece and are therefore completely consumed as opposed to a more traditional medium such as applesauce wherein a patient may not consume the entire spoonful and may be require to have the spoon re-administered to completely empty the spoon.

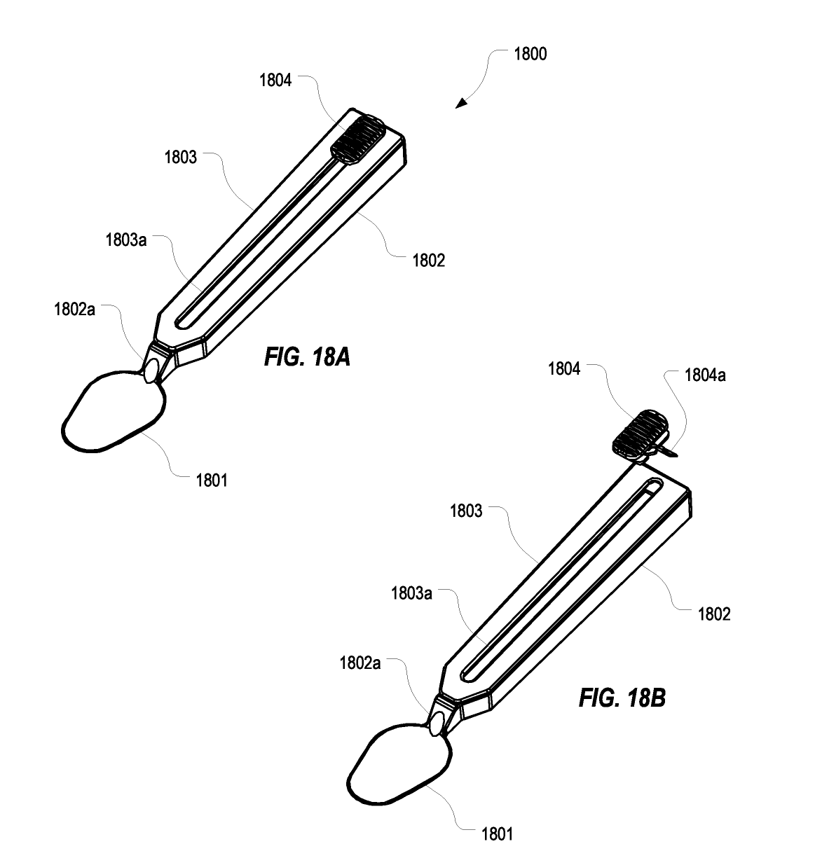

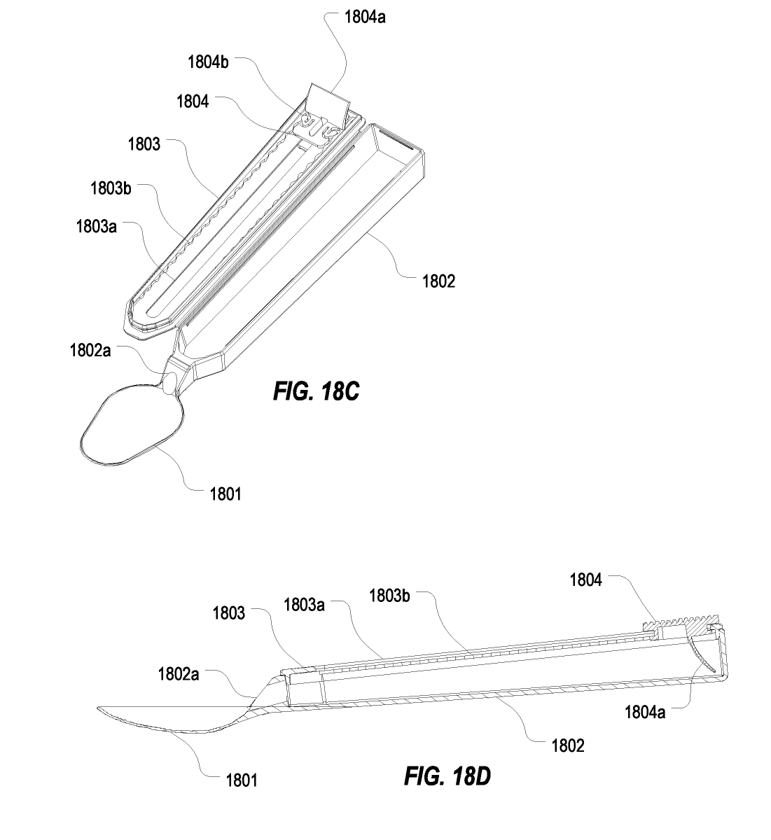

FIGS. 18A-18D illustrate a spoon 1800 having a hollow handle in which a packaged carrier medium can be placed. As shown, spoon 1800 includes a bowl 1801, a handle 1802 that is hollow and includes a hole 1802a forming an opening into bowl 1801, a cover 1803, and a sliding member 1804. As shown in FIG. 18C, cover 1803 opens to provide access to the hollow interior of handle 1802. Cover 1803 includes a longitudinal slot 1803a within which sliding member 1804 slides. As best shown in FIG. 18D, sliding member 1804 includes a blade 1804a which extends into the hollow interior of handle 1802. Initially, sliding member 1804 can be positioned as shown in FIGS. 18C and 18D to allow a package containing a carrier medium to be loaded into handle 1802. Hole 1802a can be configured to receive an end of the package and, in some embodiments, secure the end within the hole (e.g., via grooves, protrusions, etc.). Then, with cover 1803 closed and the package inside handle 1802, sliding member 1804 can be slid towards bowl 1801. As sliding member 1804 is slid, blade 1804a can apply a force to the carrier medium to cause it to be expelled from the package, through hole 1802a, and into bowl 1801 where it can be consumed. The carrier medium may include a medication in some embodiments. Alternatively, a medication may be placed in bowl 1801 before, while, or after the carrier medium is expelled into bowl 1801 where it can be mixed with the carrier medium. In some embodiments, the carrier medium may be directly placed (i.e., without packaging) inside the hollow interior of handle 1802. In such embodiments, longitudinal slot 1803a may be configured to form a seal to prevent the carrier medium from exiting the handle through the slot.

As shown in FIG. 18C, cover 1803 can include a series of ridges 1803b while sliding member 1804 can include compressible protrusions 1804b which insert between ridges 1803b. The interaction between protrusions 1804b and ridges 1803b can cause sliding member 1804 to slide in incremental distances along cover 1803 (e.g., by clicking). In some embodiments, cover 1803 can include one or more markings which each identify a quantity of the carrier medium that will be expelled into bowl 1801 when sliding member 1804 is slid to the marking Each marking can correspond with a particular ridge 1803b. For example, if handle 1802 is sized to hold a package containing 100 mL of carrier medium, markings may be placed along cover 1803 in locations that correspond with the ridges into which protrusions 1804b would need to be positioned to cause a 25 mL, a 50 mL, a 75 mL, and a 100 mL dose to be dispensed into bowl 1801. Once a carrier medium is consumed, the package that contained the carrier medium can be removed from handle 1802 and a different package can be inserted to allow spoon 1800 to be reused.

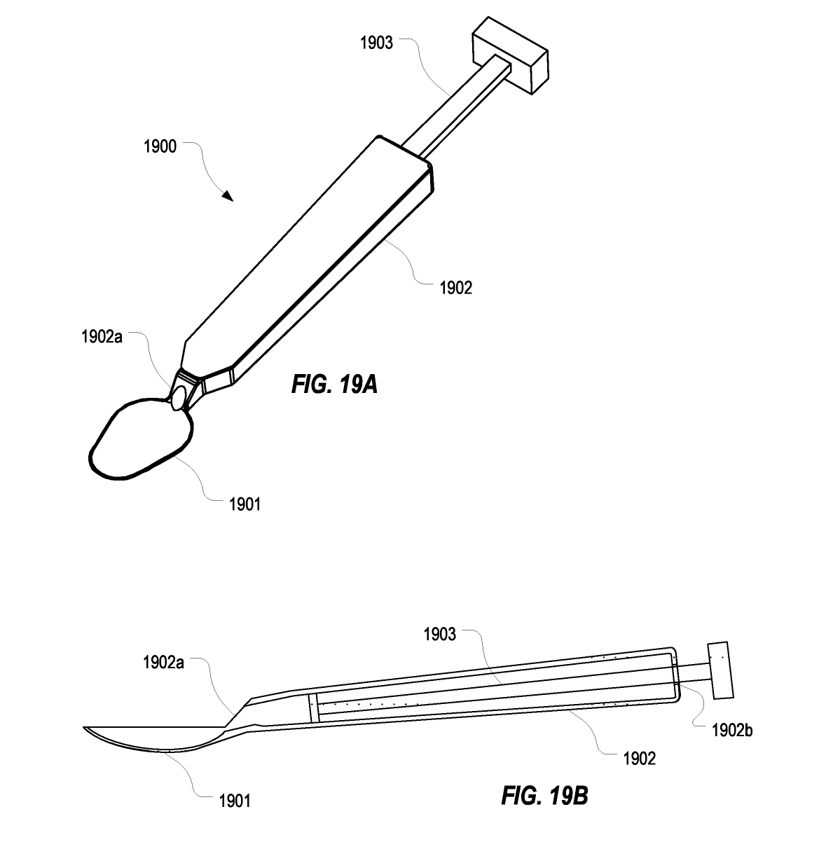

FIGS. 19A and 19B illustrate a spoon 1900 that also includes a hollow handle into which a carrier medium can be placed. Spoon 1900 includes a bowl 1901, a handle 1902 that is hollow and includes a hole 1902a that forms an opening into bowl 1901, and a plunger 1903. Plunger 1903 can be used in a similar manner as a syringe to cause the carrier medium to be expelled from handle 1902 into bowl 1901 through hole 1902a. Handle 1902 may be prefilled with a carrier medium in which case a seal may be placed over hole 1902a which can be pierced or separated when the carrier medium is to be dispensed.

In some embodiments, spoon 1900 can be configured to be reusable. For example, handle 1902 can include a cover (not shown, but may be similar to cover 1803) to allow a package containing the carrier medium to be placed within handle 1902. In other embodiments, handle 1902 can be configured to allow plunger 1903 to be removed from end 1902b thereby allowing the carrier medium to be injected into handle 1902 or a package containing the carrier medium to be inserted into handle 1902. Once the carrier medium is injected into handle 1902 or a package is inserted into handle 1902, plunger 1903 could then be reinserted through end 1902b. In embodiments where a packaged carrier medium is employed, hole 1902a can be configured to receive and possibly secure (e.g., via grooves, protrusions, etc.) an end of the package.

In some embodiments, plunger 1903 may include markings along its length which indicate how much carrier medium will be expelled into bowl 1901 when plunger 1903 is inserted into handle 1902 a certain distance. As with spoon 1800, the carrier medium placed in spoon 1900 may include a medication in some embodiments. Alternatively, a medication may be placed in bowl 1901 before, while, or after the carrier medium is expelled into bowl 1901 where it can be mixed with the carrier medium.

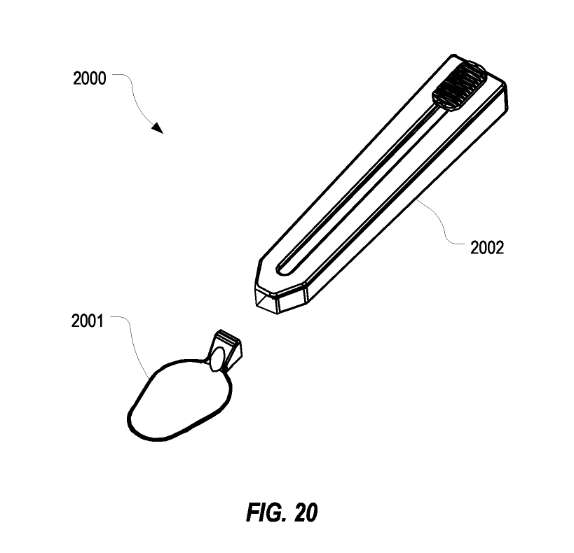

FIG. 20 illustrates a spoon 2000 that includes a bowl 2001 that is removable from handle 2002. Spoon 2000 is similar to spoon 1800; however, a removable bowl may be incorporated into any of the disclosed spoon designs. Bowl 2001 may be configured to attach to handle 2002 in various ways. For example, bowl 2001 and handle 2002 can be configured to allow bowl 2001 to snap into/onto handle 2002. In such embodiments, bowl 2001 can be removed from handle 2002 either by pulling the two components apart or by pressing a switch or latch on either handle 2002 or bowl 2001. Bowl 2001 and handle 2002 could also be configured with threads to allow bowl 2001 to be screwed onto handle 2002.

In any of the above described embodiments that employ a hollow handle to contain and dispense a carrier medium, the handle can be used without a bowl. For example, handles 1802 and 1902 could be used without bowls 1801 and 1901 respectively by ejecting the carrier medium through hole 1802a/1902a directly into the mouth of an individual.

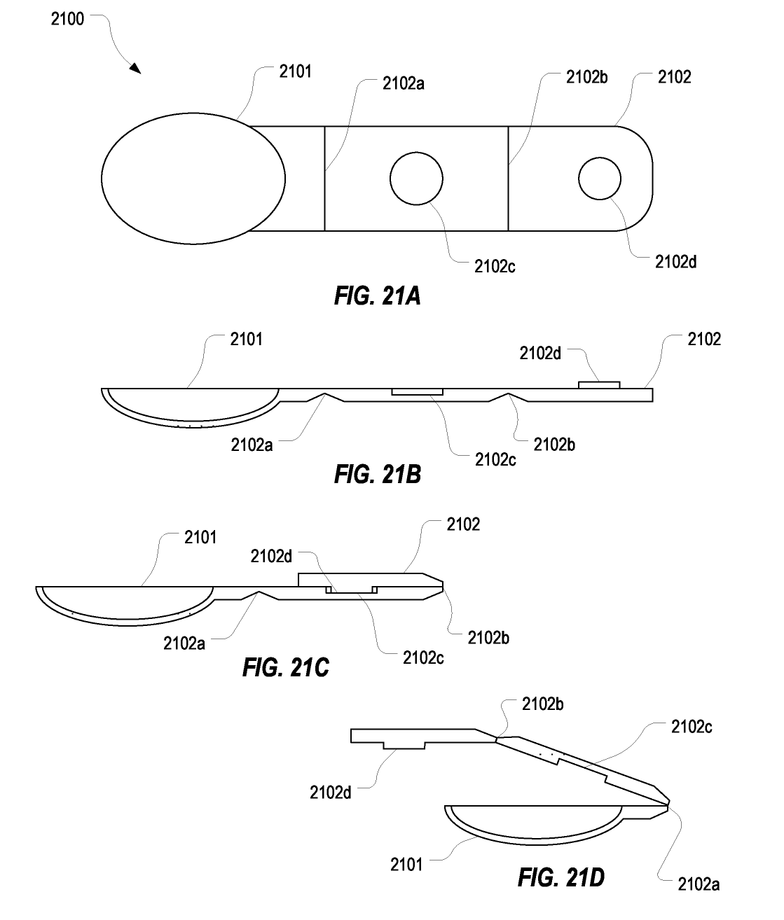

FIGS. 21A-21D illustrate a spoon 2100 that can be folded to crush a pill. As shown, spoon 2100 includes a bowl 2101 and a handle 2102. Handle 2102 includes two folding regions 2102a, 2102b which allow handle 2102 to be folded. Handle 2102 also includes a receptacle area 2102c and a crushing area 2102d. As shown in FIG. 21C, handle 2102 can be folded along folding region 2102b to cause crushing area 2102d to insert into receptacle area 2102c thereby crushing any pill contained in receptacle area 2102c. Then, as shown in FIG. 21D, handle 2102 can be folded along folding region 2102a to cause receptacle area 2102c to be positioned above bowl 2101 thereby causing any crushed pill to be dispensed into bowl 2101.

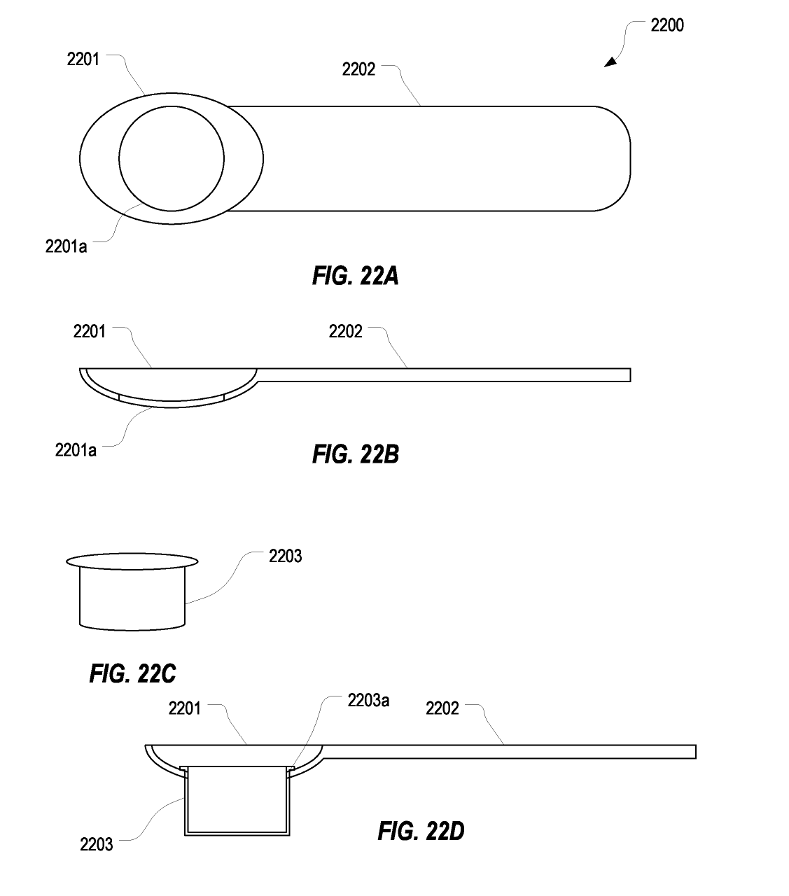

FIGS. 22A-22D illustrate a spoon 2200 having a handle 2202 and a bowl 2201 within which is formed an opening 2201a. Opening 2201a allows a cup 2203 to be placed within bowl 2201. Cup 2203 can include an upper surface 2203a having a diameter slightly larger than the diameter of opening 2201a so that upper surface 2203a rests on the surface of bowl 2201 thereby holding cup 2203 within bowl 2201 as shown in FIG. 22D. Cup 2203 can contain a carrier medium which can include a medication or which can be mixed with a medication that is separately added to bowl 2201. Once the carrier medium in cup 2203 is consumed, the cup can be discarded and spoon 2200 can be reused with another cup.

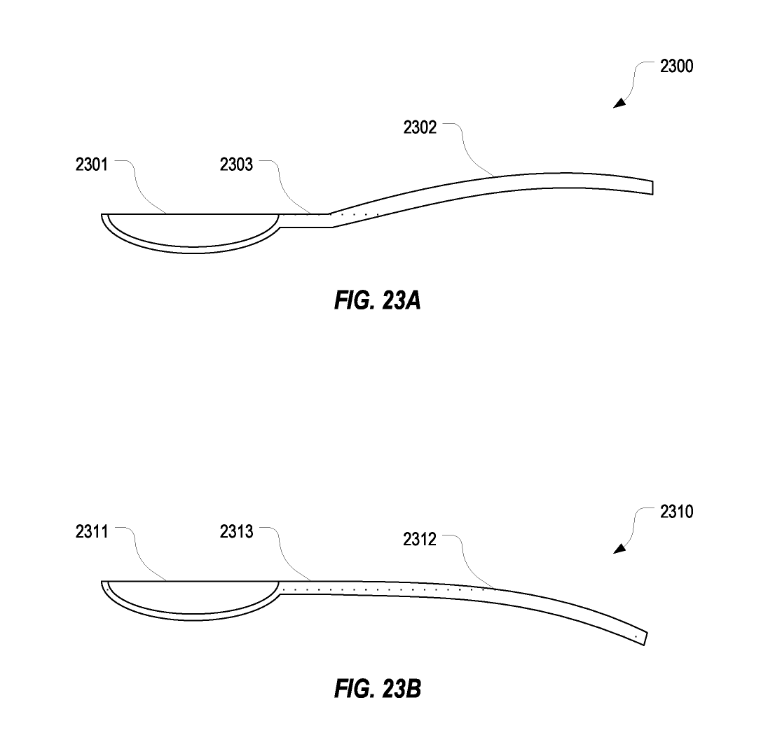

FIG. 23A illustrates a spoon 2300 having a bowl 2301, an arched handle 2302 that is angled upward, and a flat region 2303 between bowl 2301 and arched handle 2302. Flat region 2303 facilitates applying a seal overtop of bowl 2301 since flat region 2303 is planar with the top surface of bowl 2301. FIG. 23B illustrates a similar spoon 2310 having a bowl 2311, an arched handle 2312 that is angled downward, and a flat region 2313.

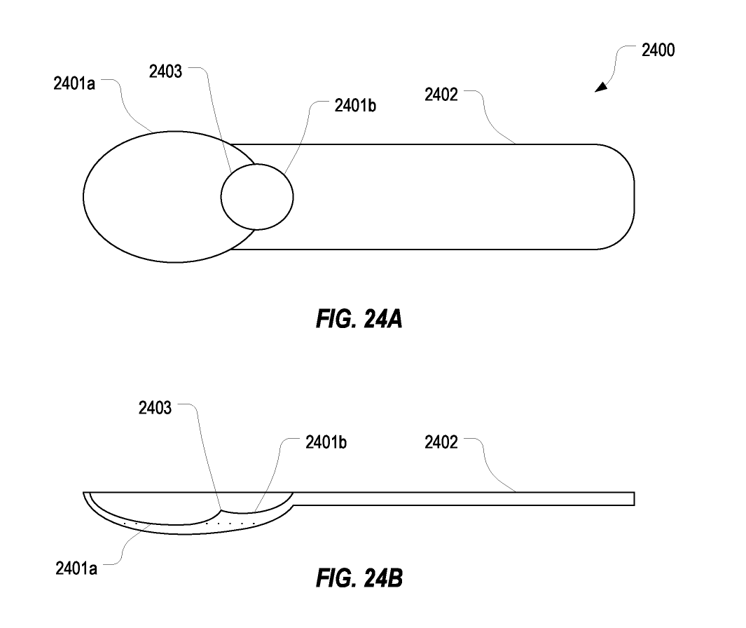

FIGS. 24A and 24B illustrate a spoon 2400 having multiple bowls. Spoon 2400 includes a primary bowl 2401a, a secondary bowl 2401b, and a handle 2402. Primary bowl 2401a and secondary bowl 2401b share an edge 2403, but primary bowl 2401a is deeper than secondary bowl 2401b. Edge 2403 can be lower than a top surface of primary bowl 2401a as is shown in FIG. 24B. Alternatively, edge 2403 can be at the same level as the top surface of primary bowl 2401a. In some embodiments, a carrier medium can be placed in primary bowl 2401a and a medication can be placed in secondary bowl 2401b. The medication can then be gradually transferred from secondary bowl 2401b into primary 2401a for mixing with the carrier medium. This can reduce the amount of spillage that may occur during mixing.

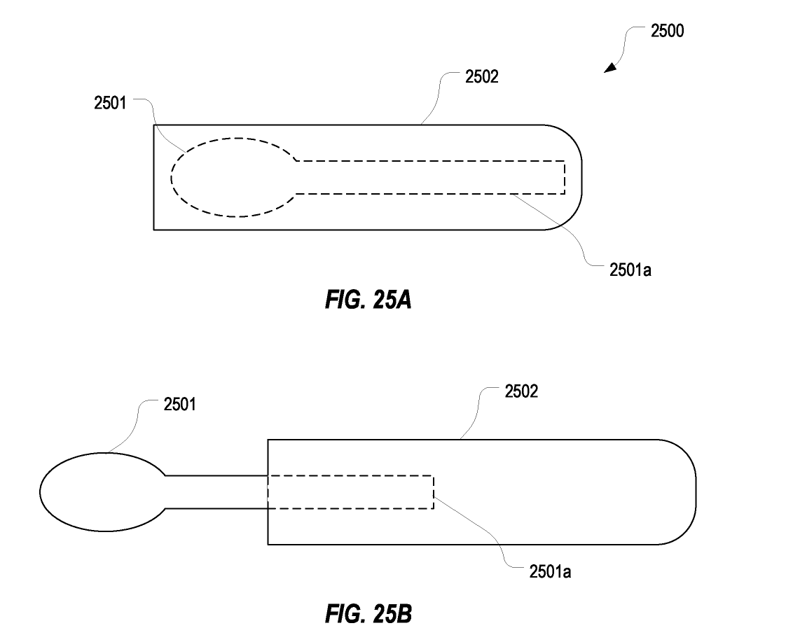

FIGS. 25A and 25B illustrate a spoon 2500 having a sliding bowl. Spoon 2500 includes a bowl 2501 having an extension 2501a and a handle 2502 into which bowl 2501 retracts. FIG. 25A shows bowl 2501 in a retracted position while FIG. 25B shows bowl 2501 in an extended position. In some embodiments, extension 2501a can be configured to prevent bowl 2501 from being separated from handle 2502. In other embodiments, extension 2501a can be configured to allow bowl 2501 to be removed from handle 2502 so that a new bowl can be inserted into handle 2502. Bowl 2501, in some embodiments, can contain a carrier medium and/or medication over which a seal is placed.

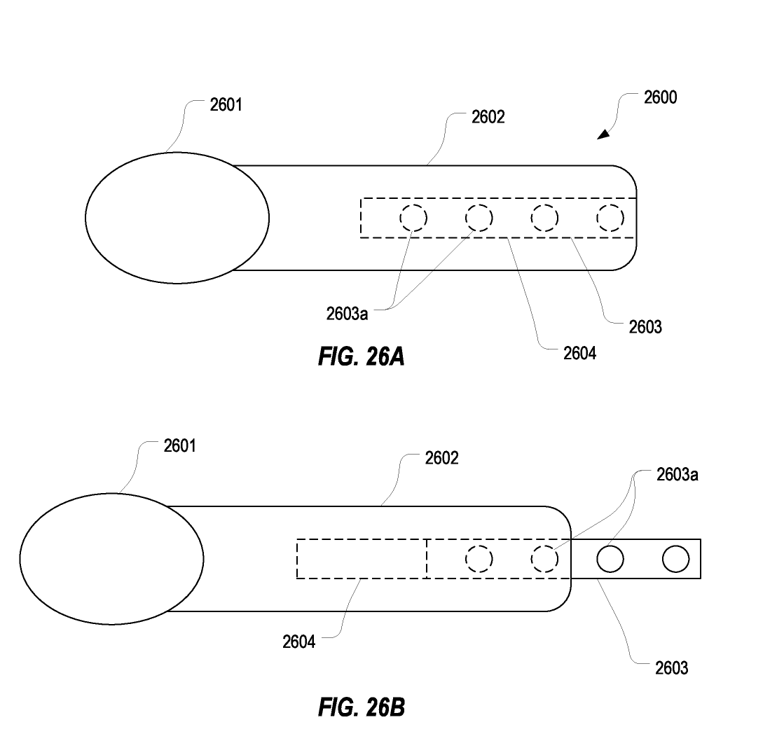

FIGS. 26A and 26B illustrate a spoon 2600 that includes a number of compartments for storing medication (e.g., pills). Spoon 2600 includes a bowl 2601 and a handle 2602. Handle 2602 includes a channel 2604 in which a strip 2603 is contained. Strip 2603 includes a number of compartments 2603a for storing medication such as pills. Strip 2603 can be slid out from channel 2604 to provide access to compartments 2603a as needed. Although FIGS. 26A and 26B illustrate channel 2604 as being formed on a bottom side of or inside handle 2602, channel 2604 could also be formed on a top side of handle 2602. Strip 2603 can have a sufficient thickness to allow compartments 2603a to be appropriately sized to contain pills or other medications. In embodiments where channel 2604 is formed on a surface of handle 2602, compartments 2603a can be configured to protrude out from the surface of the handle.

In some embodiments, a bowl of a spoon may be formed of an edible material to allow a patient to consume the bowl along with any carrier medium or medication that the bowl may contain. In any of the above described embodiments, the carrier medium can be a nutritional or non-nutritional item in the form of a liquid, powder, pudding, or gel. The carrier medium may, in some embodiments, also include a medication. Also, in any of the above described embodiments, the bowl may be prefilled with a medication or carrier medium and sealed. For example, spoons 1800, 1900, and 2000 could have their bowls prefilled with a medication that can be mixed with a carrier medium that is injected from the handles. Also, spoons 2100, 2300, 2400, 2500, and 2600 could have their bowls prefilled with a carrier medium and/or medication and sealed.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed:

1. A spoon for administering a carrier medium comprising:
a bowl; and
a handle attached to the bowl, the handle having a hollow interior and including a hole forming an opening from the hollow interior to the bowl thereby allowing a carrier medium contained within the hollow interior to be expelled from the hollow interior into the bowl.

2. The spoon of claim 1, further comprising:
a cover that opens to provide access to the hollow interior, the cover having a slot; and
a sliding member that slides within the slot, the sliding member including a blade that extends into the hollow interior, the blade configured to provide a force against a package of carrier medium contained within the hollow interior to cause the carrier medium to be expelled into the bowl.

3. The spoon of claim 2, wherein the cover includes a series of ridges and the sliding member includes one or more compressible protrusions that insert between the ridges to cause the sliding member to slide in incremental distances.

4. The spoon of claim 2, wherein the cover includes one or more markings that each identify an amount of carrier medium that will be expelled into the bowl by sliding the sliding member to the marking.

5. The spoon of claim 2, wherein the bowl includes a medication that is sealed within the bowl.

6. The spoon of claim 1, further comprising:
a plunger that inserts into the handle to force the carrier medium through the hole and into the bowl.

7. The spoon of claim 6, further comprising:
a seal over the hole.

8. The spoon of claim 1, wherein the bowl is removable from the handle to allow another bowl to be attached to the handle.

9. A spoon for administering a carrier medium comprising:
a bowl; and
a handle that extends proximally from the bowl, the handle including a first folding region, a second folding region proximal to the first folding region, a receptacle area between the first and second folding regions, and a crushing area positioned proximal to the second folding region, wherein when the handle is folded along the second folding region, the crushing area inserts into the receptacle area.

10. The spoon of claim 9, wherein when the handle is folded along the first folding region, the receptacle area is positioned overtop the bowl.

11. A spoon for administering a carrier medium comprising:
a bowl; and
a handle.

12. The spoon of claim 11, wherein the bowl includes an opening into which a cup containing a carrier medium or medication can be placed.

13. The spoon of claim 12, wherein the cup has a top portion having a diameter that is greater than the diameter of the opening to thereby maintain the cup suspended from the opening.

14. The spoon of claim 11, wherein the handle is arched, the spoon further comprising:
a flat region positioned between the bowl and the handle, the flat region being planar with a top surface of the bowl.

15. The spoon of claim 14, wherein the handle is arched upward or downward from the bowl.

16. The spoon of claim 11, wherein the bowl is a primary bowl, the spoon further comprising;
a secondary bowl adjacent the primary bowl.

17. The spoon of claim 16, wherein the primary bowl is deeper than the secondary bowl.

18. The spoon of claim 11, wherein the bowl is retractable from the handle.

19. The spoon of claim 11, wherein the handle includes a channel within which a strip slides, the strip including a number of compartments for storing a carrier medium or medication.

20. The spoon of claim 19, wherein the bowl contains a carrier medium and is sealed.
